(19) United States
(12) Patent Application Publication
(10) Pub. No.: US 2009/0006958 A1
(43) Pub. Date: Jan. 1, 2009

(54) Method, Apparatus and Computer Program Product for Providing an Object Selection Mechanism for Display Devices

(75) Inventors: Teemu Pohjola, Helsinki (FI); Roope Rainisto, Helsinki (FI); Ashley Colley, Oulu (FI); Piiastiina Tikka, Oulu (FI); Morten Elvang-Goransson, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 11/771,096

(22) Filed: Jun. 29, 2007

(51) Int. Cl. G06F 3/00

(52) U.S. Cl. 715/710

(57) ABSTRACT

An apparatus for providing an object selection mechanism for touch screen devices may include a processing element. The processing element may be configured to receive an indication of a detection of an event associated with a display, determine a type of the event, determine a candidate object associated with the type of the event, and generate a user interface component based on the determination of the candidate object.

### TECHNOLOGICAL FIELD

Embodiments of the present invention relate generally to user interface technology and, more particularly, relate to a method, apparatus, and computer program product for providing an object selection mechanism for display devices.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. The services may be provided from a network server or other network device, or even from the mobile terminal such as, for example, a mobile telephone, a mobile television, a mobile gaming system, etc.

In many situations, it may be desirable for the user to interface with a device such as a mobile terminal for the provision of an application or service. A user's experience during certain applications such as, for example, web browsing may be enhanced by using a touch screen display as the user interface. Furthermore, some users may have a preference for use of a touch screen display for entry of user interface commands over other alternatives. In recognition of the utility and popularity of touch screen displays, many devices, including some mobile terminals, now employ touch screen displays.

Touch screen devices are now relatively well known in the art, with numerous different technologies being employed for sensing a particular point at which an object may contact the touch screen display. In an exemplary situation, pressure detection may be sensed over a relatively small area and the detection of such pressure may be recognized as a selection of an object, link, item, hotspot, etc. associated with the location of the detection of the pressure. A familiar mechanism which has been used in conjunction with touch screen displays is a stylus. However, a pen, pencil or other pointing device may often be substituted for a dedicated instrument to function as a stylus. Such devices may be advantageous since they provide a relatively precise mechanism by which to apply pressure that may be detected over a corresponding relatively small area and can therefore be recognized as indicative of a user's intent to select a corresponding object, link, item, hotspot, etc. In this regard, for example, the optimal size of a hotspot area for a typical touch screen user interface utilizing a stylus may be about 3 mm² to about 8 mm². A stylus or similar device may be capable of routinely providing an input that is detectable with accuracy within such limitations.

Some users may consider it cumbersome to routinely remove or acquire a stylus or other pointing device to utilize a touch screen user interface. Accordingly, touch screen user interfaces have been developed in which a finger can be used to provide input to the touch screen user interface. However, a finger is typically larger than a stylus and therefore often provides a less accurate input to the touch screen user interface or require a larger hotspot area for the provision of accurate results. For example, an optimal size of a hotspot area for a typical touch screen user interface for use with fingers may be about 8 mm² to about 20 mm². Additionally, the finger may block portions of the screen thereby making it difficult to see what is being selected. Accordingly, particularly in situations where the touch screen user interface is utilized in connection with a device having a relatively small sized display such as a mobile terminal, the use of fingers with touch screen displays may present accuracy problems that may reduce user enjoyment or even increase user dissatisfaction with a particular application or service.

Accordingly, it may be desirable to provide a mechanism for overcoming at least some of the disadvantages discussed above.

### BRIEF SUMMARY

A method, apparatus and computer program product are therefore provided for providing an object selection mechanism for display devices. In particular, a method, apparatus and computer program product are provided that determine a type of event associated with visualization using a display and provide a determination of candidate objects based on the type of event. A user interface may then be provided based on the determined candidate objects.

In one exemplary embodiment, a method of providing an object selection mechanism for display devices is provided. The method may include receiving an indication of a detection of an event associated with a display, determining a type of the event, determining a candidate object associated with the type of the event, and generating a user interface component based on the determination of the candidate object.

In another exemplary embodiment, a computer program product for providing an object selection mechanism for display devices is provided. The computer program product includes at least one computer-readable storage medium having computer-readable program code portions stored therein. The computer-readable program code portions include first, second, third and fourth executable portions. The first executable portion is for receiving an indication of a detection of an event associated with a display. The second executable portion is for determining a type of the event. The third executable portion is for determining a candidate object associated with the type of the event. The fourth executable portion is for generating a user interface component based on the determination of the candidate object.

In another exemplary embodiment, an apparatus for providing an object selection mechanism for display devices is provided. The apparatus may include a processing element. The processing element may be configured to receive an indication of a detection of an event associated with a display, determine a type of the event, determine a candidate object associated with the type of the event, and generate a user interface component based on the determination of the candidate object.

In another exemplary embodiment, an apparatus for providing an object selection mechanism for display devices is provided. The apparatus includes means for receiving an indication of a detection of an event associated with a display, means for determining a type of the event, means for determining a candidate object associated with the type of the event, and means for generating a user interface component based on the determination of the candidate object.

Embodiments of the invention may provide a method, apparatus and computer program product for improving display interface. More specifically, according to one embodiment, touch screen interface performance for use with a finger may be improved. As a result, for example, mobile terminal users may enjoy improved capabilities with respect to web browsing and other services or applications that may be used in connection with a display such as a touch screen display.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIGS. 2A and 2B are schematic block diagrams of an apparatus for providing an object selection mechanism for display devices according to an exemplary embodiment of the present invention;

FIGS. 3A and 3B illustrate exemplary displays according to an exemplary embodiment of the present invention;

FIGS. 4A and 4B illustrate exemplary displays according to an exemplary embodiment of the present invention;

FIG. 5 illustrates an example of a touch screen display having a plurality of links according to an exemplary embodiment of the present invention; and

FIG. 6 is a block diagram according to an exemplary method for providing an object selection mechanism for display devices according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

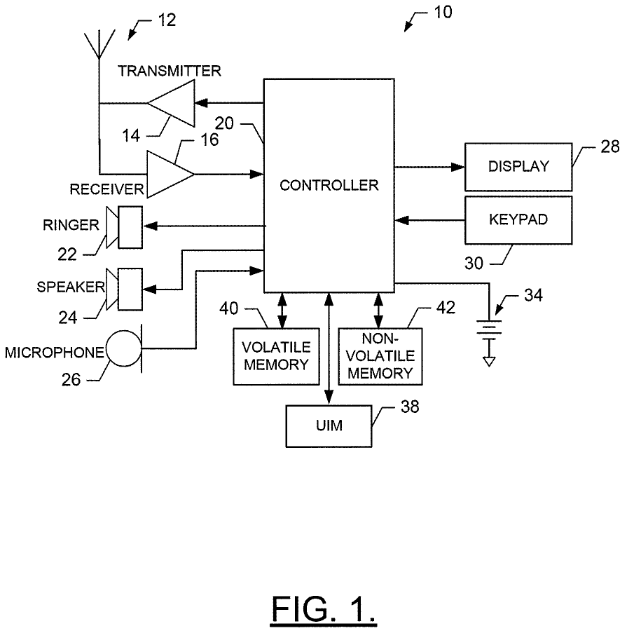

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols or the like.

It is understood that the controller 20 includes circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer 22, a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

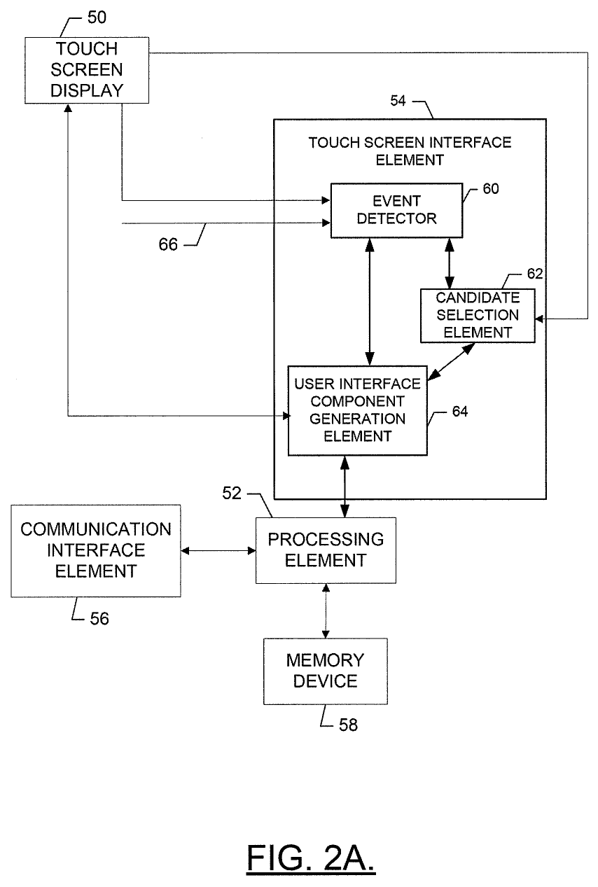

An exemplary embodiment of the invention will now be described with reference to FIG. 2, in which certain elements of a system for providing a link selection mechanism for display devices such as, for example, touch screen devices are displayed. The system of FIG. 2 may be employed, for example, in conjunction with the mobile terminal 10 of FIG. 1. However, it should be noted that the system of FIG. 2, may also be employed in connection with a variety of other devices, both mobile and fixed, and therefore, embodiments of the present invention should not be limited to application on devices such as the mobile terminal 10 of FIG. 1. It should also be noted that while FIG. 2 illustrates one example of a configuration of a system for providing a link selection mechanism for touch screen devices, numerous other configurations may also be used to implement embodiments of the present invention. Moreover, although an exemplary embodiment of the present invention described below will generally refer to link selection in the context of a web browsing application, embodiments of the present invention more generally relate to any selectable object which may include without limitation selection of any of plain text links, clickable page elements, buttons, hotspots, list or grid items, etc.; all of which are generally referred to herein as links or objects. Furthermore, although an embodiment of the present invention is described below in reference to a touch screen display, other embodiments may also be practiced in association with display devices that are not necessarily touch screen displays.

Referring now to FIG. 2A, an apparatus for providing an object selection mechanism for display devices is provided. The apparatus may include a touch screen display 50 (e.g., the display 28) a processing element 52 (e.g., the controller 20), a touch screen interface element 54, a communication interface element 56 and a memory device 58. The memory device 58 may include, for example, volatile and/or non-volatile memory (e.g., volatile memory 40 and/or non-volatile memory 42). The memory device 58 may be configured to store information, data, applications, instructions or the like for enabling the apparatus to carry out various functions in accordance with exemplary embodiments of the present invention. For example, the memory device 58 could be configured to buffer input data for processing by the processing element 52. Additionally or alternatively, the memory device 58 could be configured to store instructions for execution by the processing element 52.

The processing element 52 may be embodied in a number of different ways. For example, the processing element 52 may be embodied as a processor, a coprocessor, a controller or various other processing means or devices including integrated circuits such as, for example, an ASIC (application specific integrated circuit). In an exemplary embodiment, the processing element 52 may be configured to execute instructions stored in the memory device 58 or otherwise accessible to the processing element 52. Meanwhile, the communication interface element 56 may be embodied as any device or means embodied in either hardware, software, or a combination of hardware and software that is configured to receive and/or transmit data from/to a network and/or any other device or module in communication with the apparatus.

The touch screen display 50 may be embodied as any known touch screen display. Thus, for example, the touch screen display 50 could be configured to enable touch recognition by any suitable technique, such as resistive, capacitive, infrared, strain gauge, surface wave, optical imaging, dispersive signal technology, acoustic pulse recognition, etc. techniques. The touch screen interface element 54 may be in communication with the touch screen display 50 to receive indications of user inputs at the touch screen display 50 and to modify a response to such indications based on the type of user input determined responsive to the indication and possibly also based on predefined parameters or rules regarding the treatment of such indications. In this regard, the touch screen interface element 54 may be any device or means embodied in either hardware, software, or a combination of hardware and software configured to perform the respective functions associated with the touch screen interface element 54 as described below. In an exemplary embodiment, the touch screen interface element 54 may be embodied in software as instructions that are stored in the memory device 58 and executed by the processing element 52. Alternatively, touch screen interface element 54 may be embodied as the processing element 52.

The touch screen interface element 54 may be configured to receive an indication of an input in the form of a touch event at the touch screen display 50. A touch event may be defined as an actual physical contact between an object (e.g., a finger, stylus, pen, pencil, or other pointing device) and the touch screen display 50. Alternatively, a touch event may be defined as bringing the object in proximity to the touch screen display 50. In dependence upon an event detected at the touch screen display 50, the touch screen interface element 54 may modify a response to the touch event. In this regard, the touch screen interface element 54 may include an event detector 60, a candidate selection element 62 and a user interface component generation element 64. Each of the event detector 60, the candidate selection element 62 and the user interface component generation element 64 may be any device or means embodied in either hardware, software, or a combination of hardware and software configured to perform the corresponding functions associated with the event detector 60, the candidate selection element 62 and the user interface component generation element 64, respectively, as described below. In an exemplary embodiment, each of the event detector 60, the candidate selection element 62 and the user interface component generation element 64 may be controlled by or otherwise embodied as the processing element 52.

The event detector 60 may be in communication with the touch screen display 50 to determine a type of event based on each input received at the event detector 60. In this regard, for example, the event detector 60 may be configured to receive an indication of a detection of an event associated with a display and determine the type of input received. The type of input received may be, in one embodiment, either a hit event or a miss event relative to an object being rendered on the touch screen display 50. In an exemplary embodiment, a miss may be experienced when a touch event position does not correspond to the position of a displayed object and a hit may be experienced when the touch event position corresponds to the position of a displayed object.

In an exemplary embodiment, the touch screen display 50 may provide characteristics of a detection of a touch event such as information indicative of a size of the object touching the touch screen display 50 (e.g., pressure per unit area) as a portion of the information communicated for the indication of the detection. As such, characteristics corresponding to a size of the object touching the touch screen display 50 being above a particular threshold may be designated to correspond to a finger and thereby trigger the event detector 60 to identify the indication of the detection of the touch event as a finger touch event. As another example, the event detector 60 may receive an input indicative of a stylus being sheathed or otherwise stored. Accordingly, if the stylus is stored, the event detector 60 may determine that any object touching the touch screen display 50 is likely a finger. Other mechanisms for determining that the indication of a touch event corresponds to a finger touch (e.g., a touch event associated with a relatively blunt object) or a stylus touch (e.g., a touch event associated with a relatively pointed object) may also be employed such as magnetic, electrical resistance or other techniques. For example, the event detector 60 may receive an external input 66 to determine a mode of operation (e.g., finger touch or stylus touch mode) to determine whether the indication of the touch event corresponds to a finger touch or a stylus touch. As another example of an alternative embodiment, the event detector 60 may receive a manual mode selection input via the external input 66 such as a hardware toggle switch or via a menu selection made at the touch screen display 50 (e.g., selecting a corresponding control in a toolbar) or via a dedicated or other, e.g., soft, key in a separate user interface such as a keyboard.

As stated above, the event detector 60 may be configured to determine the type of the detected event (e.g., miss event or hit event of a displayed object). The event detector 60 may then communicate the type of event to either or both of the candidate selection element 62 and the user interface component generation element 64. In an exemplary embodiment, if the event detector 60 determines a miss or hit, the event detector 60 may enable the operation of the candidate selection element 62 and the user interface component generation element 64 as described below.

The candidate selection element 62 may be configured to determine candidate links (or objects) in response to the type event. In this regard, for example, due to the ambiguity associated with determining a target of a touch event that is initiated with a finger, embodiments of the present invention may intelligently select candidate links that could be potential targets of the touch event. In an exemplary embodiment, candidate links may be determined based on proximity of various links to the touch event. As such, if a touch event is detected at a particular portion of the touch screen display 50, links within proximity to the touch event may be designated as candidate links. According to one example implementation, a radius of a circular area (e.g., a consideration circle) may define an area in which, if any portion of a link falls within the area, the link may be considered a candidate link. The radius may therefore define a distance from the touch event that may be used for candidate link determination. Although a circle may be used, it should be noted that other shapes could also be employed in embodiments of the present invention such as elliptical, irregular, polygonal, etc.

In an exemplary embodiment, a distance associated with determining candidate links may be variable. In this regard, for example, if a touch event is detected to be proximate to, but not directly on, one or more links within a predetermined threshold distance, each link within the threshold distance may be considered to be a candidate link. However, if a touch event is detected to be a direct hit with respect to a link, the threshold distance may be reduced to a smaller size for candidate link determination. Accordingly, even if a direct hit is detected, a candidate link determination may still be performed since, given the ambiguity that may be associated with a finger initiated touch event, the direct hit may not necessarily be associated with the actual intended target of the touch event. The threshold distance (e.g., a size of the consideration circle) may be determined based on the type of event and/or whether the event is a finger touch event or a stylus tough event. The threshold distance may also be determined based on screen size or resolution of the touch screen display 50.

Once one or more candidate links are determined by the candidate selection element 62, information identifying the one or more candidate links may be communicated to the component generation element 64. The component generation element 64 may be configured to generate a modified or alternative user interface component which may be communicated to the touch screen display 50 for visualization at the display based on the information. In an exemplary embodiment, the modified user interface component may differ from an original user interface component in a variety of ways. For example, the modified user interface component may be presented in a different interaction or presentation style than the original user interface component (e.g., a vertical list may be replaced with a grid). As another example, the modified user interface may be presented with a different characteristic, but in either the same or a different relative location. The different characteristic could be related to highlighting of the candidate link, dimming parts of the page other than the candidate link, enlarging the candidate link, reordering candidate links, etc. If link reordering is utilized, such reordering may be performed on the basis of a probability order with links having higher probability being, for example, higher on a list or otherwise more prominently displayed than links with lower probability. In this regard, candidate links closer to the location of the touch event may be considered to have a higher probability of being an intended target than candidate links farther from the location of the touch event. Alternatively, candidate links having a higher hit rate may be considered to have a higher probability of being an intended target than candidate links having a lower hit rate.

In operation, there may be essentially four possible outcomes for the detection of a touch event. Such outcomes may include a direct hit of a link with a stylus (or other pointed tool, or tool with a well defined tip), a missed link with the stylus, a direct hit of a link with a finger (or other object without a well defined tip) and a missed link with the finger. As such, the type of event could be defined more particularly to include not only a hit or miss of a link, but also whether the hit or miss was detected in connection with a finger touch event or a stylus touch event. In an exemplary embodiment, in response to a direct hit of a link or a missed link with a stylus, the event detector 60 may determine a response corresponding to normal operation. In this regard, for example, if the link is hit with the stylus, the link may be considered selected as normal and a corresponding function may be performed (e.g., connecting to the linked object, text, web page, etc.). If the link is missed, nothing may occur (as is normal browser behavior). In response to a direct hit of a link or a missed link with a finger, the event detector 60 may operate correspondingly as described below. Accordingly, if the link is hit, a reduced size consideration circle may be applied to determine candidate links, which may then be presented in a modified user interface component. (Similar performance with the same or even a smaller consideration circle could alternatively be provided for a miss with the stylus). However, if the link is missed (e.g., user presses a portion of the display that does not include any link), a larger size consideration circle may be applied to determine candidate links, which may be presented in the modified user interface component. (Similar performance with the same or even a smaller consideration circle could alternatively be provided for a hit with the stylus). If no candidate links are determined (e.g., no links within the consideration circle) in response to the missed link, nothing may occur (according to normal browser behavior).

After presentation of the modified user interface, the user may select the intended target from among the candidate links presented in the modified user interface. Selection of the intended target from the candidate links may cause execution of the function associated with the selected link (e.g., connecting to the linked object, text, web page, etc.). However, if the intended target is not present or if the touch event was accidentally inserted, the user may insert another touch event in a blank area of the screen where no candidate links may be determined and the user may reattempt to select the intended target. If a touch event is detected in an area in which no candidate links are present, the touch event may be ignored. If such a touch event is detected when a modified user interface is being presented, the modified user interface may be cleared since the detection of a touch even with no candidate links may be understood to indicate an intentionally missed link and no other action may be performed in response to the touch event. The fact that two selections may be utilized to achieve execution of the function associated with the selected link may still be more efficient than backing out of unintended executions due to incorrectly recognized touch events in conventional touch screen implementations.

In an alternative embodiment, as shown in FIG. 2B, a touch screen display need not be employed. In this regard, according to the exemplary embodiment of FIG. 2B, an event detector 60′ may be used in combination with other elements similar to those described above in reference to FIG. 2A except that display 50′ may not necessarily be a touch screen display and thus, display interface element 54′ need not be configured to interface with a touch screen display. According to the embodiment of FIG. 2B, the event detector 60′ may be any device or means embodied in either hardware, software, or a combination of hardware and software configured to detect or otherwise receive an indication of the detection of an event associated with a visualization on the display 50′ and determine a type of the event. In this regard, the indication of the detection of the event may be, for example, an indication of a finger touch event (e.g., a touch event associated with a relatively blunt object), an indication of a stylus touch event (e.g., a touch event associated with a relatively pointed object), an indication of an event associated with a hardware driven control mechanism (e.g., a mouse, rollerball, rocker, etc.). The determined type of event may correspond to a hit event or a miss event associated with the indicated touch event. The event detector 60′ may then communicate the type of event to the candidate selection element 62, which may be configured to determine candidate links (or objects) in response to the determined type of event.

In accordance with this exemplary embodiment, the component generation element 64 may be configured to generate a modified or alternative user interface component which may be communicated to the display 50 for visualization at the display based on the determination of the candidate objects and/or based upon the determined type of event. For example, if a miss event or a hit event is determined, candidate links may be selected as described above in reference to FIG. 2A and visualized as described above in reference to FIG. 2A. However, in response to the indication of the event being associated with the hardware driven control mechanism (e.g., a hardware navigation event), candidate links may be selected based on a consideration circle of a different (perhaps smaller) size than that which would be utilized in connection with a finger touch event. Similarly, in response to the indication of the event being associated with the stylus, a consideration circle of different size may also be utilized. A visualization of the candidate links may then be provided either similar to the manner described above in reference to FIG. 2A, or in a different manner. For example, the visualization of candidate links may be different and tailored to the type of event (e.g., hit or miss) in further consideration of whether the determined type of event occurs in connection with the finger touch event, the stylus touch event or the hardware driven control mechanism event.

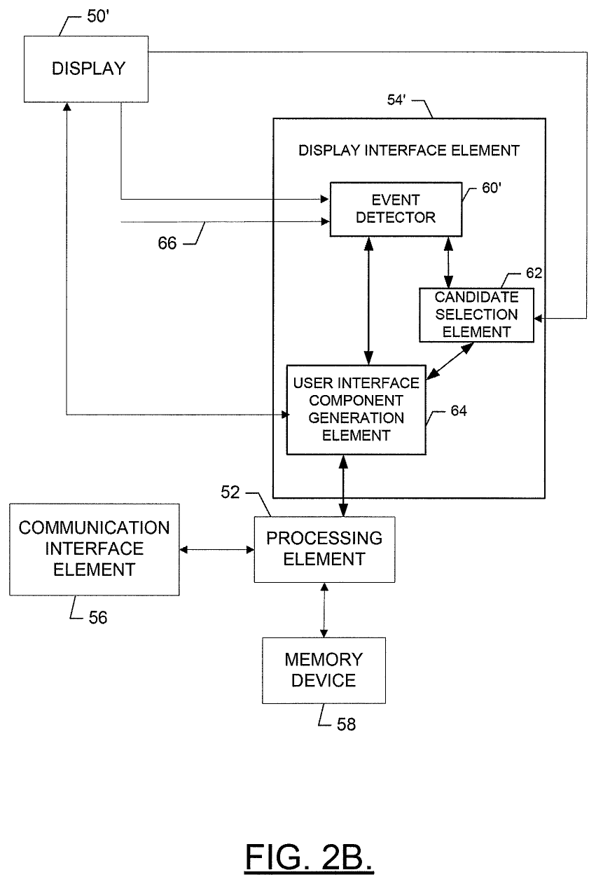

FIGS. 3A and 3B illustrate exemplary displays according to an exemplary embodiment of the present invention. In this regard, FIG. 3A illustrates an exemplary touch screen display having an original user interface component in the form of a scrollbar 70. FIG. 3B illustrates a modified user interface component in response to detection of a touch event proximate to the scrollbar (e.g., a miss event detected near the scroll bar in which the scroll bar is within the consideration circle). As shown in FIG. 3B, a modified scrollbar 72 may be presented in an enlarged scale.

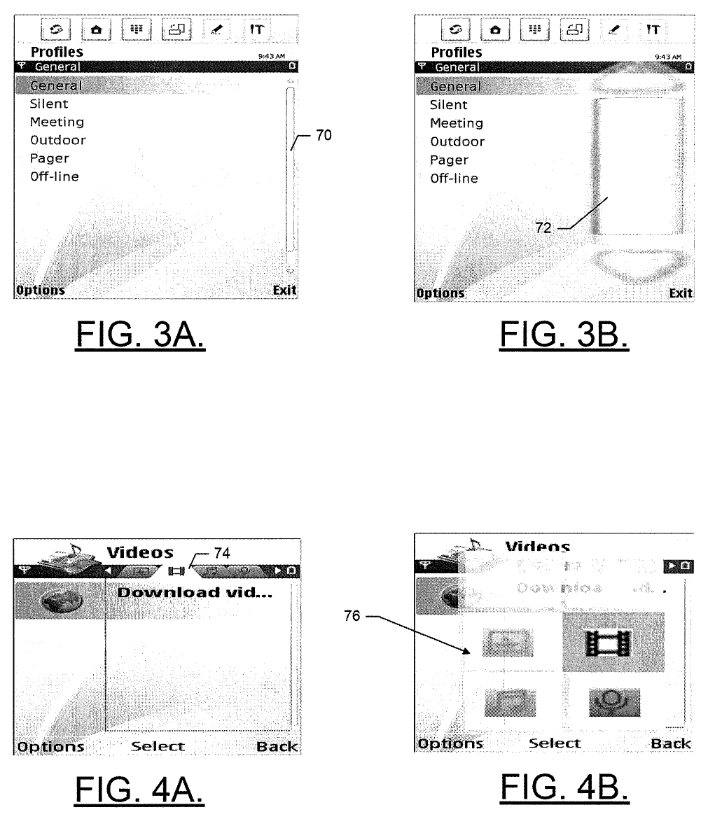

FIGS. 4A and 4B also illustrate exemplary displays according to an exemplary embodiment of the present invention. In this regard, FIG. 4A illustrates an exemplary touch screen display having an original user interface component in the form of a navigation pane 74. FIG. 4B illustrates a modified user interface component in response to detection of a touch event proximate to the navigation pane (e.g., a miss event detected near the navigation pane in which the navigation pane is within the consideration circle). As shown in FIG. 4B, a modified navigation pane 76 may be presented in an enlarged scale. Moreover, the modified navigation pane 76 is also presented in a different interaction style than the navigation pane 74.

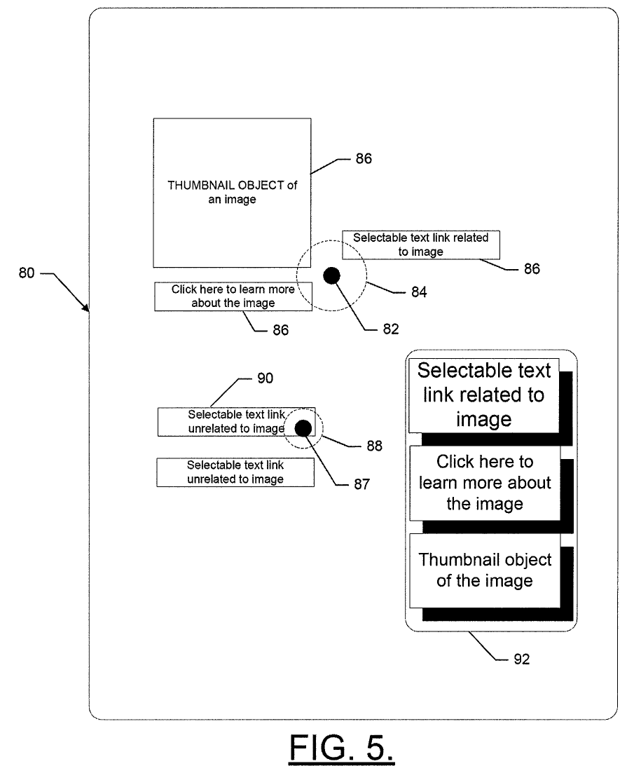

FIG. 5 illustrates an example of a touch screen display 80 having a plurality of links. As shown in FIG. 5, in response to detection of a touch event 82 at a particular location that is not a direct hit of a link, any links within a first consideration circle 84 of a first radius may be designated as candidate links 86. However, in response to detection of a touch event 87 at a particular location that is a direct hit of a link, any links within a second consideration circle 88 of a second radius smaller than the first radius may be designated as a candidate link 90. FIG. 5 also illustrates an example of a modified user interface component 92 corresponding to the touch event 82. Notably, although FIG. 5 illustrates touch events and corresponding consideration circles, such representations are merely shown for purposes of example and may not actually be visualized on the touch screen display. In response to candidate link determination, the candidate links may be presented in a manner similar to that described above. In an embodiment where a large number of candidate links exist, only a predetermined number of candidate links may be displayed, for example, based on the most likely links among the candidate links.

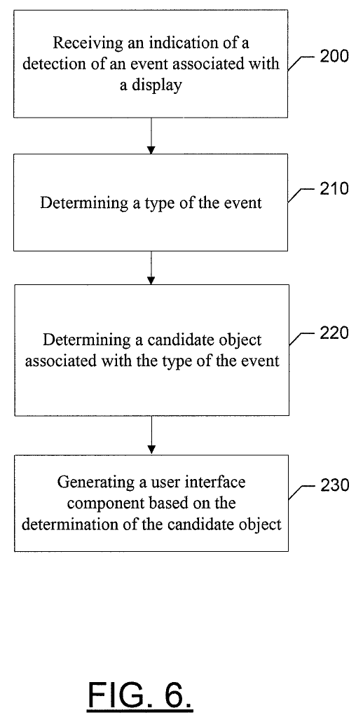

FIG. 6 is a flowchart of a method and program product according to exemplary embodiments of the invention. It will be understood that each block or step of the flowchart, and combinations of blocks in the flowchart, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal and executed by a built-in processor in the mobile terminal. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In an exemplary embodiment, as illustrated in FIG. 6, a method for providing an object selection mechanism in a display device may include detection of an indication of an event associated with a display visualization at operation 200. The event may be, for example, a finger touch event, a stylus touch event or a hardware driven control mechanism event. A type of the event may be determined at operation 210. The type of event may be, for example, a hit event or a miss event. In an exemplary embodiment, the type of event may be further defined by whether the type of event is associated with the finger touch event, the stylus touch event or the hardware driven control mechanism event. A determination of candidate objects associated with the determined type of event may be accomplished at operation 220. At operation 230, a user interface component may be generated at the display based on the determined candidate objects. Additionally or alternatively, the user interface component may be generated based on the determined type of event.

In an exemplary embodiment, operation 230 may include generating a modified user interface component having a different interaction style than a corresponding original user interface component associated with the touch event. In this regard, generating the modified user interface component may include reordering candidate objects according to a probability based order or maintaining object relative location of the modified user interface component or varying the object relative location of the modified user interface component.

The above described functions may be carried out in many ways. For example, any suitable means for carrying out each of the functions described above may be employed to carry out embodiments of the invention. In one embodiment, all or a portion of the elements of the invention generally operate under control of a computer program product. The computer program product for performing the methods of embodiments of the invention includes a computer-readable storage medium, such as the non-volatile storage medium, and computer-readable program code portions, such as a series of computer instructions, embodied in the computer-readable storage medium.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a detection of an event associated with a display;
determining a type of the event;
determining a candidate object associated with the type of event; and
generating a user interface component based on the determination of the candidate object.

2. A method according to claim 1, wherein receiving the indication of the detection of the event comprises receiving an indication of a stylus touch event, a finger touch event or a hardware navigation event.

3. A method according to claim 2, wherein receiving the indication of the touch event comprises determining the finger touch event in response to a detection occurring while a stylus sensor indicates that a corresponding stylus is stored.

4. A method according to claim 1, wherein determining the candidate object comprises determining the candidate object based on a distance of the candidate object being within a threshold distance from the event.

5. A method according to claim 4, further comprising determining the threshold distance to be a first distance in response to the type of event being a direct hit of an object and determining the threshold distance to be a second distance that is larger than the first distance in response to the type of event not being a direct hit of the object.

6. A method according to claim 1, wherein generating the user interface component comprises generating a modified user interface component having a different interaction style than a corresponding original user interface component associated with the event.

7. A method according to claim 6, wherein generating the modified user interface component comprises reordering candidate objects according to a probability based order.

8. A method according to claim 6, wherein generating the modified user interface component comprises maintaining object relative location of the modified user interface component or varying the object relative location of the modified user interface component.

9. A method according to claim 1, wherein generating the user interface component further comprises generating the user interface component based on the type of the event.

10. A method according to claim 9, wherein determining the type of the event comprises determining a miss event or a hit event.

11. A computer program product comprising at least one computer-readable storage medium having computer-readable program code portions stored therein, the computer-readable program code portions comprising:
a first executable portion for receiving an indication of a detection of an event associated with a display;
a second executable portion for determining a type of the event;
a third executable portion for determining a candidate object associated with the type of event; and
a fourth executable portion for generating a user interface component based on the determination of the candidate object.

12. A computer program product according to claim 11, wherein the first executable portion includes instructions for receiving an indication of a stylus touch event, a finger touch event or a hardware navigation event.

13. A computer program product according to claim 12, wherein the first executable portion includes instructions for determining the finger touch event in response to a detection occurring while a stylus sensor indicates that a corresponding stylus is stored.

14. A computer program product according to claim 11, further comprising a fifth executable portion for determining the candidate object based on a distance of the candidate object being within a threshold distance from the event.

15. A computer program product according to claim 14, further comprising a sixth executable portion for determining the threshold distance to be a first distance in response to the type of event being a direct hit of an object and determining the threshold distance to be a second distance that is larger than the first distance in response to the type of event not being a direct hit of the object.

16. A computer program product according to claim 11, wherein the fourth executable portion includes instructions for generating a modified user interface component having a different interaction style than a corresponding original user interface component associated with the event.

17. A computer program product according to claim 16, wherein the fourth executable portion includes instructions for comprises reordering candidate objects according to a probability based order.

18. A computer program product according to claim 16, wherein the fourth executable portion includes instructions for maintaining object relative location of the modified user interface component or varying the object relative location of the modified user interface component.

19. A computer program product according to claim 11, wherein the fourth executable portion includes instructions for generating the user interface component based on the type of the event.

20. A computer program product according to claim 19, wherein the second executable portion includes instructions for determining a miss event or a hit event.

21. An apparatus comprising a processing element configured to:
receive an indication of a detection of an event associated with a display;
determine a type of the event;
determine a candidate object associated with the type of event; and
generate a user interface component based on the determination of the candidate object.

22. An apparatus program product according to claim 21, wherein the processing element is further configured to receive an indication of a stylus touch event, a finger touch event or a hardware navigation event.

23. An apparatus program product according to claim 22, wherein the processing element is further configured to determine a finger touch event in response to a detection occurring while a stylus sensor indicates that a corresponding stylus is stored.

24. An apparatus program product according to claim 21, wherein the processing element is further configured to determine the candidate object based on a distance of the candidate object being within a threshold distance from the event.

25. An apparatus program product according to claim 24, wherein the processing element is further configured to determine the threshold distance to be a first distance in response to the type of event being a direct hit of an object and determine the threshold distance to be a second distance that is larger than the first distance in response to the type of event not being a direct hit of the object.

26. An apparatus program product according to claim 21, wherein the processing element is further configured to generate a modified user interface component having a different interaction style than a corresponding original user interface component associated with the event.

27. An apparatus program product according to claim 26, wherein the processing element is further configured to reorder candidate objects according to a probability based order.

28. An apparatus program product according to claim 26, wherein the processing element is further configured to maintain object relative location of the modified user interface component or varying the object relative location of the modified user interface component.

29. An apparatus according to claim 21, wherein the processing element is further configured to generate the user interface component based on the type of the event.

30. An apparatus according to claim 29, wherein the processing element is further configured to determine a miss event or a hit event.

31. An apparatus comprising:
means for receiving an indication of a detection of an event associated with a display;
means for determining a type of the event;
means for determining a candidate object associated with the type of event; and
means for generating a user interface component based on the determination of the candidate object.

32. An apparatus according to claim 31, further comprising means for generating a modified user interface component having a different interaction style than a corresponding original user interface component associated with the event.
